(19) United States
(12) Patent Application Publication
(10) Pub. No.: US 2017/0060246 A1
(43) Pub. Date: Mar. 2, 2017

(54) METHOD FOR REMOTELY SHARING TOUCH

(71) Applicant: Tactus Technology, Inc., Hayward, CA (US)

(72) Inventor: Micah Yairi, Hayward, CA (US)

(73) Assignee: Tactus Technology, Inc., Hayward, CA (US)

(21) Appl. No.: 15/347,574

(22) Filed: Nov. 9, 2016

Related U.S. Application Data
(63) Continuation of application No. 14/196,311, filed on Mar. 4, 2014.
(60) Provisional application No. 61/774,203, filed on Mar. 7, 2013.

(51) Int. Cl. G06F 3/01; H04M 1/725; G06F 3/14; G06F 3/0488

(52) U.S. Cl. CPC G06F 3/016; G06F 3/0488; H04M 1/72519; G06F 3/1454

(57) ABSTRACT

One variation of a method for remotely sharing touch includes: receiving a location of a touch input on a surface of a first computing device; receiving an image related to the touch input; displaying the image on a display of a second computing device, the second computing device comprising a dynamic tactile layer arranged over the display and defining a set of deformable regions, each deformable region in the set of deformable region configured to expand from a retracted setting into an expanded setting; and transitioning a particular deformable region in the set of deformable regions from the retracted setting into the expanded setting, the particular deformable region defined within the dynamic tactile layer at a position corresponding to the location of the touch input.

### CROSS-REFERENCE TO RELATED APPLICATIONS

This application is a continuation of U.S. patent application Ser. No. 14/196,311, filed 4 Mar. 2014, which claims the benefit of U.S. Provisional Application No. 61/774,203, filed on 7 Mar. 2013, both of which are incorporated in their entirety by this reference.

### TECHNICAL FIELD

This invention relates generally to computing devices, and more specifically to a new and useful the method for remotely sharing touch across computing devices.

### BRIEF DESCRIPTION OF THE FIGURES

FIG. 1 is a flowchart of a method of one embodiment of the invention;

FIG. 2 is a flowchart of one variation of the method;

FIG. 3 is a flowchart of one variation of the method;

FIG. 4 is a flowchart of one variation of the method;

FIG. 5 is a flowchart of one variation of the method; and

FIG. 6 is a flowchart of one variation of the method.

### DESCRIPTION OF THE PREFERRED EMBODIMENTS

The following description of the preferred embodiment of the invention is not intended to limit the invention to these preferred embodiments, but rather to enable any person skilled in the art to make and use this invention.

### 1. Method and Applications

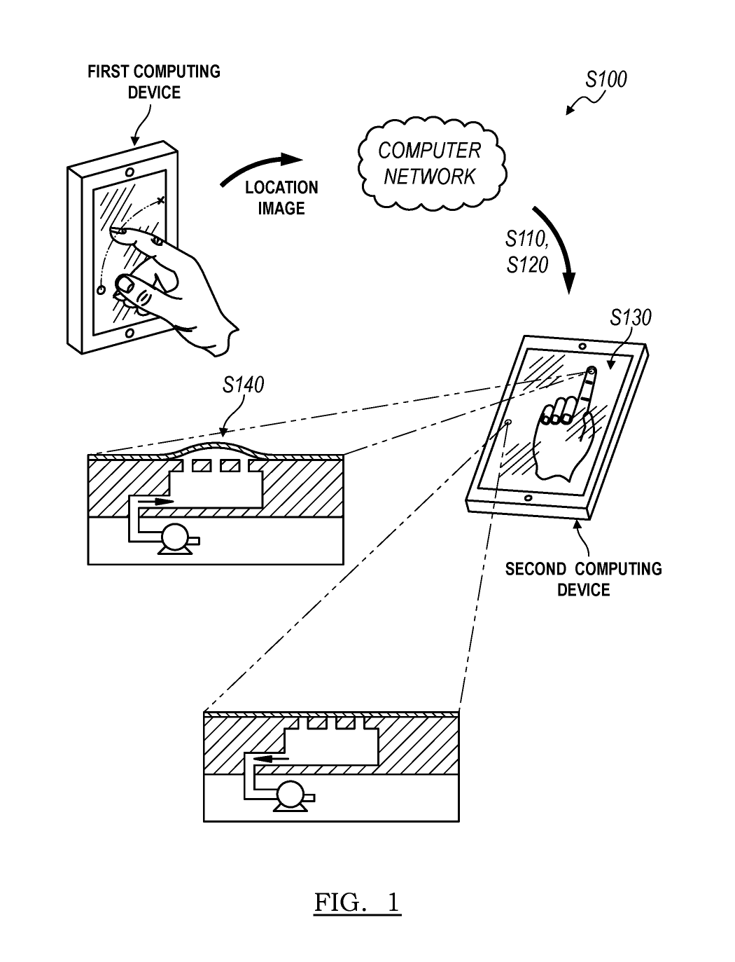

As shown in FIG. 1, a method for remotely sharing touch includes: receiving a location of a touch input on a surface of a first computing device in Block S110; receiving an image related to the touch input in Block S120; displaying the image on a display of a second computing device in Block S130, the second computing device including a dynamic tactile layer arranged over the display and defining a set of deformable regions, each deformable region in the set of deformable region configured to expand from a retracted setting into an expanded setting; and, in response to receiving the location of the touch input, transitioning a particular deformable region in the set of deformable regions from the retracted setting into the expanded setting in Block S140, the particular deformable region defined within the dynamic tactile layer at a position corresponding to the location of the touch input.

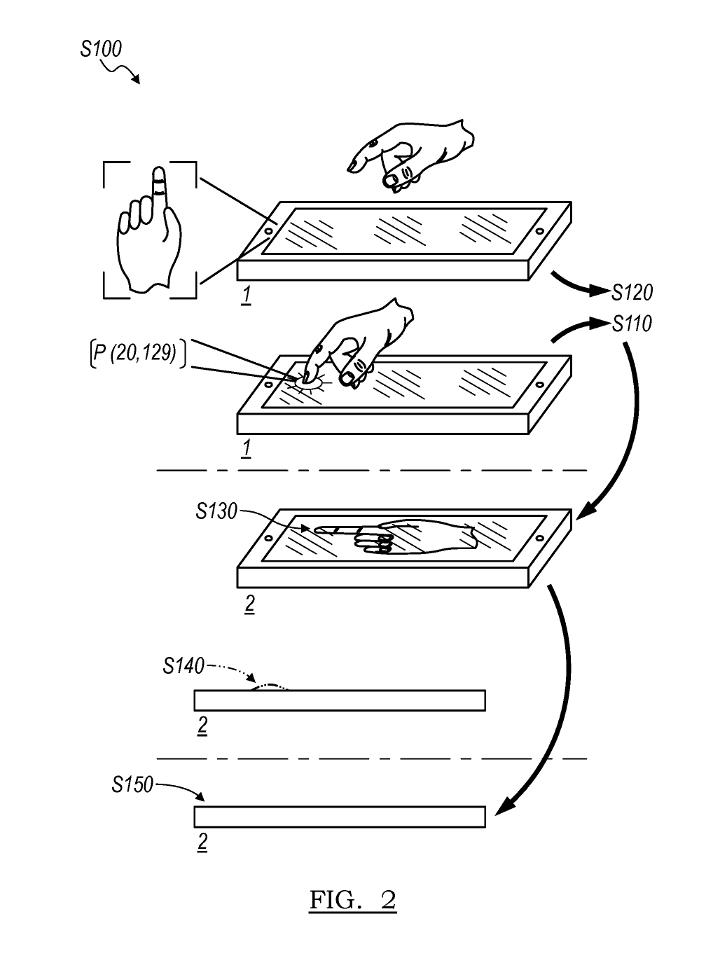

As shown in FIG. 2, one variation of the method includes: at a second mobile computing device, receiving a location of a touch input on a surface of a first mobile computing device in Block S110; receiving an image of an object applying the touch input onto the surface of the first mobile computing device in Block S120; displaying the image on a display of the second mobile computing device in Block S130, the second mobile computing device including a dynamic tactile layer arranged over the display and defining a set of deformable regions, each deformable region in the set of deformable region configured to expand from a retracted setting into an expanded setting; transitioning a particular deformable region in the set of deformable regions from the retracted setting into the expanded setting in Block S140, the particular deformable region defined within the dynamic tactile layer at a position corresponding to the location of the touch input and elevated above the dynamic tactile layer in the expanded setting; and transitioning the particular deformable region from the expanded setting into the retracted setting in response to withdrawal of the object from the location on the surface of the first mobile computing device in Block S150, the particular deformable region substantially with the dynamic tactile layer in the retracted setting.

Generally, the method functions to share a sense of touch across two computing devices by imitating a form of an object contacting a first computing device on a surface of a second computing device. The method can further display an actual image or representative image of the object with the imitated form on the second computing device to provide—at the second computing device—both tactile and visual feedback of the object in contact with or adjacent the first computing device. Blocks S110 and S120 of the method can therefore execute on the second computing device and/or on a computer network in communication with the first computing device to collect touch-related data, and Blocks S130 and S140, etc. can execute on the second computing device to display an image and to produce a tactile formation on the second computing device and corresponding to the touch on the first computing device. For example, the method can receive—directly or indirectly from the first computing device—a position, size, geometry, pressure, temperature, and/or other parameter, variable, or rate of change of these parameters or variables related to a touch (e.g., with a finger or stylus by a first user) on a surface of the first computing device. The method can then control a dynamic tactile layer (e.g., a dynamic tactile interface) in the second computing device to imitate or mimic a touch input on the first computing device, thereby communicating a sense of touch from the first computing device to the second computing device, such as wireless or over a wired connection.

The method can therefore be implemented between two or more computing devices (e.g., between two smartphones or tablets) to share or communicate a sense of touch between two users (i.e., people) separated by some distance. In one example, the method is implemented on a first computing device that is a first smartphone carried by a first businessman and on a second computing device that is a second smartphone carried by a second business man. In this example, the first and second smartphones each include a dynamic tactile interface as described below such that the first and second businessmen may shake hands remotely by each holding his respective smartphone as if to shake it like a hand. In particular, the method executing on the first smartphone can manipulate its respective dynamic tactile interface to imitate the sensation of holding the second businessman's hand, and the method executing on the second smartphone can manipulate its respective dynamic tactile interface to imitate the sensation of holding the first businessman's hand. In another example, a father can place his hand on a touchscreen of a first computing device that is a first tablet, and the method can manipulate a dynamic tactile interface on a second tablet held by the father's daughter to imitate the shape and pressure of the father's hand, thereby providing the daughter with a sensation of touching her father's hand. In this example, the father can also kiss the screen of the first tablet, and the first tablet can capture the size, geometry, and location of the father's lips. In this example, second tablet can then execute Blocks of the method to imitate the father's lips by manipulating the corresponding dynamic tactile interface to yield a tactile formation approximating the size and shape of the father's lips. However, the method can be useful in any other environment to communicate a sense of touch between remote users through any suitable computing or connected device.

The first and second computing devices can communicate touch-related data over a cellular, Wi-Fi, Bluetooth, optical fiber, or other communication network or communication channel. For example, the first and second computing devices can implement the method by communicating touch-related data over a cellular network during a phone call between the first and second computing devices. In another example, the first and second computing devices can exchange touch-related data over the Internet via a Wi-Fi connection during a video chat. In another example, data related to a touch or a gesture including one or more touches can be recorded at the first computing device and stored and later (i.e., asynchronously) communicated to the second computing device, such as in an email or text message transmitted to the second computing device. Similarly, touch-related data received by the second computing device (in real-time or asynchronously) can be stored on the second computing device (e.g., in local memory) and recalled later at one or more instances and imitated at the dynamic tactile layer on the second computing device. In this example, the touch-related data can also be shared from the second computing device to a third computing device in communication substantially in real-time or asynchronously.

However, the first and second computing devices can be any suitable type of electronic or digital device incorporating any suitable component(s) to enable wired or wireless communication of touch via method and over any suitable communication channel. The first computing device can also transmit touch to multiple other computing devices simultaneously or over time (e.g., asynchronously).

The method can be thus implemented remotely by a discrete computing device, such as the second computing device that is wirelessly connected to the first computing device to communicate a sense of touch between the computing devices via a dynamic tactile interface in at least one of the computing device. In particular, Blocks of the method can be implemented on the second computing device, such as by a native application or applet or as system level functionality accessible by various programs or applications executing on the second computing device. One or more Blocks of the method can additionally or alternatively be implemented or executed on or by the first computing device, a remote server, and/or a computer network.

Alternatively, the method can implement similar methods of techniques to replay stored touch-related data, such as touch-related data stored with an audio file, a photographic image file, or a video file on the second computing device or on a remote server and streamed or downloaded onto the second computing device. For example, a music file can be professional produced with both audio and touch-related data, the music filed downloaded from a digital store onto a user's smartphone, and the music file played on the user's smartphone to simultaneously provide an audio experience (e.g., through a speaker) and a tactile experience (i.e., at the dynamic tactile interface). In a similar example, a video file can be produced with visual, audio, and touch-related data, the video filed streamed from an online video-sharing site digital store onto the user's tablet, and the video file played on the user's tablet to simultaneously provide a visual experience (i.e., on the display within the tablet), an audio experience (e.g., through a speaker), and a tactile experience (i.e., at the dynamic tactile interface). The method can be implemented on a computing device to replay a touch or gesture previously entered into the same device.

The method can therefore augment audio and/or visual data captured at one or more remote devices and played back substantially in real-time or asynchronously on the second computing device.

### 2. First and Second Computing Devices

The first computing device can therefore include a touch sensor, such as in a touchscreen, configured to sense the position, size, pressure, texture, and/or geometry, etc. of a touch applied thereon. For example, the first computing device can be a smartphone, a tablet, a watch, a vehicle console, a desktop computer, a laptop computer, a television, a personal data assistance (PDA), a personal navigation device, a personal media or music player, a camera, or a watch that includes a capacitive, optical, resistance, or other suitable type of touch sensor configured to detect contact at one or more points or areas on the first computing device. Additionally or alternatively, the first computing device can include a mechanical sensor or any other suitable type of sensor or input region configured to capture an input onto a surface of the first computing device. The first computing device can also incorporate an optical sensor (e.g., a camera), a pressure sensor, a temperature sensor (e.g., a thermistor), or other suitable type of sensor to capture an image (e.g., a digital photographic image) of the input object (e.g., a stylus, a finger, a face, lips, a hand etc.), a force and/or breadth of an input, a temperature of the input, etc., respectfully. Any one or more of these data can then be transmitted to the second computing device, whereon these data are implemented visually and tactilely to mimic the input. The second computing device can include similar sensors configured to collect similar input data at the second computing device as a second input is supplied thereto, and any one or more of these data can then be transmitted to the first computing device, whereon these data are implemented visually and tactilely to mimic the second input.

The second computing device includes a display and a dynamic tactile interface (including a dynamic tactile layer), as described in U.S. patent application Ser. No. 11/969,848, filed on 4 Jan. 2008, U.S. patent application Ser. No. 12/319,334, filed on 5 Jan. 2009, U.S. patent application Ser. No. 13/414,589, filed on 7 Mar. 2012, U.S. patent application Ser. No. 13/456,010, filed on 25 Apr. 2012, U.S. patent application Ser. No. 13/456,031, filed on 25 Apr. 2012, U.S. patent application Ser. No. 13/465,737, filed on 7 May 2012, and U.S. patent application Ser. No. 13/465,772, filed on 7 MAY 2012, all of which are incorporated in their entirety by this reference. The dynamic tactile interface—within the second computing device—includes one or more deformable regions configured to selectively expand and retract to transiently form tactilely distinguishable formations over the second computing device.

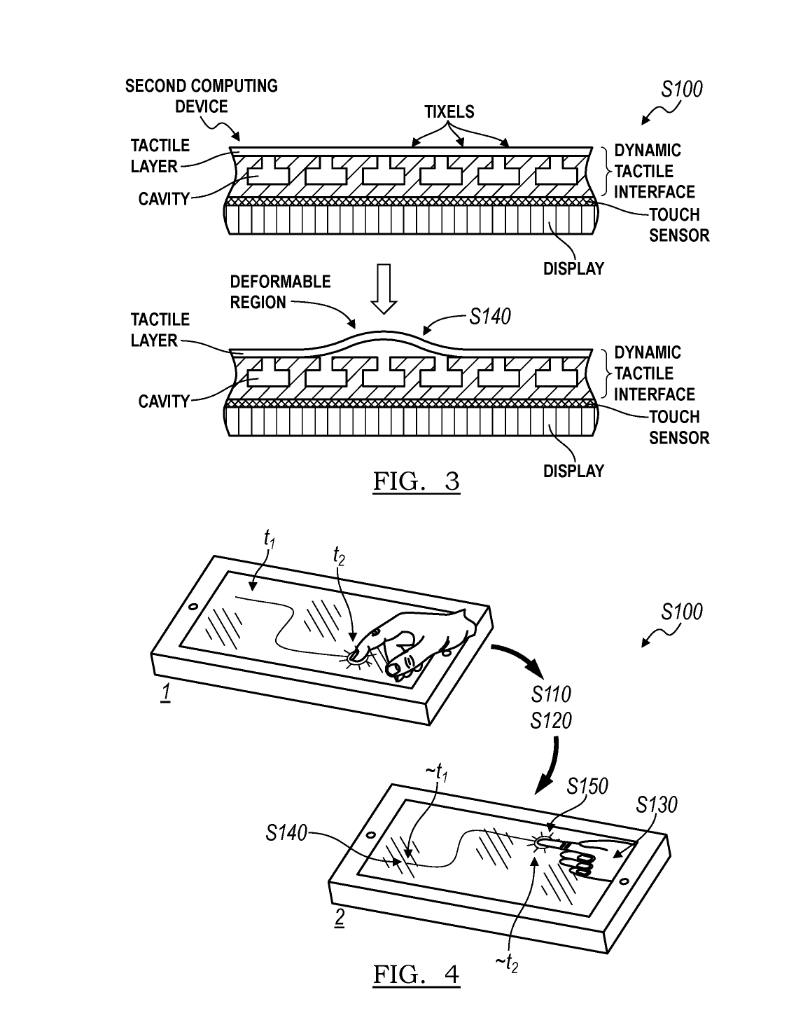

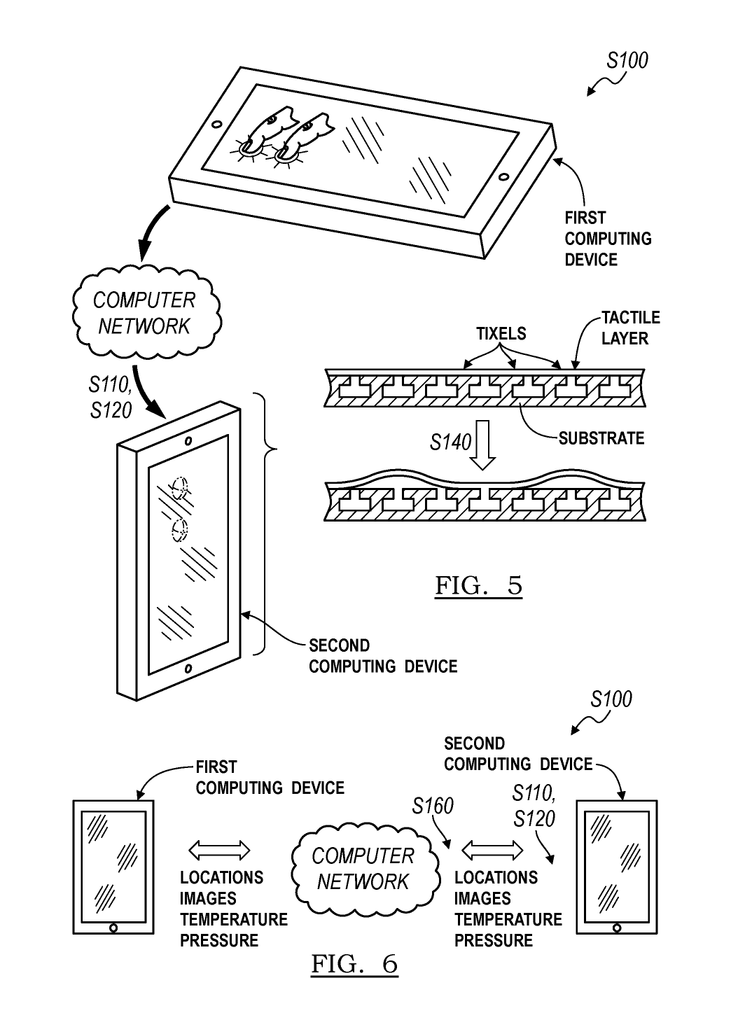

As described in U.S. patent application Ser. No. 12/319,334 and shown in FIGS. 3 and 5, the dynamic tactile interface can include: a substrate defining a fluid channel and a fluid conduit fluidly coupled to the fluid conduit; a tactile layer defining a tactile surface, deformable region, and a peripheral region, the peripheral region adjacent the deformable region and coupled to the substrate opposite the tactile surface, and the deformable region arranged over fluid conduit; and a displacement device coupled to the fluid channel and configured to displace fluid into the fluid channel to transition the deformable region from a retracted setting into an expanded setting, the deformable region tactilely distinguishable from the peripheral region at the tactile surface in the expanded setting. (In this implementation, the dynamic tactile layer can therefore include the substrate and the tactile layer.) As described in U.S. patent application Ser. No. 12/319,334, the tactile layer can also include multiple deformable regions, and the dynamic tactile interface can selectively transition the deformable regions between retracted and expanded settings in unison and/or independently, such as by actuating various valves between one or more displacement devices and one or more fluid conduits. In one implementation, the dynamic tactile interface includes an array of deformable regions patterned across the digital display in a keyboard arrangement. In another implementation, the dynamic tactile interface can include a set of deformable regions that collectively define a tixel display (i.e., pixel-level tactile display) and that can be reconfigured into tactilely-distinguishable formations in combinations of positions and/or heights to imitate a form of a touch shared from the first computing device. In yet another implementation, the dynamic tactile interface includes a set of five deformable regions arranged in a spread-finger pattern over an off-screen area region of the second computing device, wherein the five deformable regions can be selectively raised and lowered to imitate fingertip contact shared from the first computing device.

The second computing device can further include a (visual) display or a touchscreen (i.e., a display and a touch sensor in unit) arranged under the dynamic tactile layer, such as an OLED- or LED-backlit LCD display or an e-paper display. The dynamic tactile layer and fluid pumped there through can thus be substantially transparent such that an image rendered on the display below can be viewed by a user without substantial obstruction (e.g., reflection, refraction, diffraction) at the dynamic tactile layer.

The first computing device can similarly include a dynamic tactile layer, dynamic tactile interface, and/or a display. However, the first and second computing devices can include any other suitable type of dynamic tactile layer, dynamic tactile interface, display, touchscreen, or touch sensor, etc.

### 3. Touch Input Data

Block S110 of the method recites receiving a location of a touch input on a surface of a first computing device. (Block S110 of the method can similarly recite, at a second mobile computing device, receiving a location of a touch input on a surface of a first mobile computing device.) Generally, Block S110 functions to collect touch-related data from the first computing device such that Block S140 can subsequently implement these touch-related data to imitate a touch on the dynamic tactile layer of the second computing device.

As described above, Block S110 can receive touch-related data collected by a touchscreen (including a touch sensor) or by a discreet touch sensor within the first computing device. In one implementation, Block S110 receives (or collects, retrieves) touch-related data including a single touch point or multiple (e.g., four, ten) touch points on the first computing device, wherein each touch point defines an initial point of contact, a calculated centroid of contact, or other contact-related metric for a corresponding touch on a surface (e.g., a touchscreen) of the first computing device, such as with a finger or a stylus, relative to an origin or other point or feature on the first computing device or a display therefore. For example, each touch point can be defined as an X and Y coordinate in a Cartesian coordinate system with an origin anchored to a corner of the display and/or touch sensor in the first computing device.

Block S110 can additionally or alternatively receive touch-related data including one or more contact areas, wherein each contact area is defined by a perimeter of contact of an object on the first computing device, such as a contact patch of a finger or a contact patch of a hand on the surface of the first computing device. In this implementation, Block S110 can receive coordinates (e.g., X and Y Cartesian coordinates) corresponding to each discrete area of contact between the object and the surface of the first computing device in a particular contact area or corresponding to discrete areas at or adjacent the perimeter of contact between the object and the surface in the particular contact area. Additionally or alternatively, Block S110 can receive an approximate shape of a contact area, a coordinate position of the shape relative to a point (e.g., X and Y coordinates of the centroid of the shape relative to an origin of the display of the first computing device), and/or an orientation (i.e., angle) of the shape relative to an axis or origin (e.g., the X axis or short side of the display of the first computing device).

In the foregoing implementations, the first mobile computing device can calculate touch point and/or contact area data locally, such as from raw sensor data collected at the touch sensor or other related sensor within the first computing device. Alternatively, Block S110 can calculate these touch point data (e.g., on the second computing device or on a computer network) from raw touch data received from the first computing device (e.g., based on known geometries of the first and second computing devices). Block S110 can also transform contact points and/or contact areas defined in the touch-related data to accommodate a difference in size, shape, and/or orientation between the dynamic tactile layer on the second computing device and the sensor on the first computing device. For example, Block S110 can scale, translate, and/or rotate a coordinate, a group of coordinates, a centroid, or an area or perimeter defined by a coordinates corresponding to discrete areas of known size to reconcile the input on the first computing device to the size, shape, and/or orientation, etc. of the dynamic tactile layer of the second computing device.

Block S110 can also receive a temperature of a touch on the touch sensor. For example, a thermistor or infrared temperature sensor coupled to the touch sensor of the first computing device can measure a temperature of a hand or finger placed on the touch sensor of the first computing device. In this example, Block S110 can cooperate extrapolate a temperature of the touch on the first computing device based on a magnitude and/or a rate of change in a detected temperature from the temperature sensor after a touch on the first computing device is first detected. In particular, in this example, Block S110 can predict a type of input object (e.g., a finger, a stylus) from a shape of the contact area described above, select a thermal conductivity corresponding to the type of input object, and extrapolate a temperature of the input object based on a change in detected temperature on the first computing device over a known period of time based on the thermal conductivity of the input object. Alternatively, such calculation can be performed locally on the first computing device and transmitted to the second computing device in Block S110. Block S110 can similarly calculate or receive a temperature gradient across the input area. For example, Block S110 can calculate temperatures at discrete areas within the contact area based on a temperatures on the surface of the first computing device before the touch event and subsequent temperatures on the surface after the touch event, as described above, and Block S110 can then aggregate the discrete temperatures into a temperature gradient.

Block S110 can also receive a pressure and/or a force of a touch on the surface first computing device. For example, Block S110 can receive data from a strain gauge integrated into the first computing device and transform the output of strain gauge into a pressure. In this example, Block S110 can further calculate an area of the touch and convert the pressure of the touch into a force of the touch accordingly. Block S110 can also receive outputs from multiple strain gauges within the first computing device, each strain gauge corresponding to a discrete area over the surface of the first computing device, and Block S110 can thus calculate a force or pressure gradient across the surface of the first computing device. Alternatively, Block S110 can analyze a sequence of contact areas “snapshots”—paired with one or more corresponding pressures or forces based on outputs of a force or pressure sensor (e.g., a strain gauge(s)) in the first computing device—to estimate a force or pressure gradient across the input area based on changes in the contact area shape and changes in the applied forces or pressures. Alternatively, Block S110 can receive any one or more of these data calculated at the first computing device.

Block S110 can also detect a heart rate of the first user, a breathing rate, or any other vital sign of the first user, which can then be transmitted to the second computing device with other touch date. However, Block S110 can receive any other touch-related data collected by one or more sensors in the first computing device.

As described above, Block S110 can receive and/or calculate any of the foregoing touch-related data and pass these data to Block S140 to trigger remote imitation of the captured touch substantially in real-time. Alternatively, Block S110 can store any of these touch-related data locally on the second computing device—such as in memory on the second computing device—and then pass these data to Block S140 asynchronously (i.e., at a later time).

### 4. Images

Block S120 of the method recites receiving an image related to the touch input. (Block S120 can similarly recite receiving an image of an object applying the touch input onto the surface of the first mobile computing device.) Generally, Block S120 functions to receive (or collect or retrieve) a visual representation of the input object, such as a digital photographic image of the input object, a graphic representation of the input object, or a stock image (e.g., a cartoon) of the input object. Block S130 can subsequently render the image on a display of the second computing device in conjunction with expansion of a deformable region on the second computing device to visually and tactilely represent on the second computing device a touch incident on the first computing device.

In one implementation, Block S120 receives a digital photographic image captured by a camera (or other optical sensor) within the first computing device. For example, a camera arranged adjacent and directed outward from the touch sensor of the first computing device can capture the image as the input object (e.g., a finger, a hand, a face, a stylus, etc.) approaches the surface of the first computing device. In particular, when the input object reaches a threshold distance (e.g., 3 inches) from the camera and/or from the surface of first computing device, the camera can capture an image of the approaching input object. In this example, the first computing device can thus predict an upcoming touch on the touch sensor based on a distance between the camera and the input object and then capture the image accordingly, and Block S120 can then collect the image from the first computing device directly or over a connected network. Thus, in this implementation, Block S120 can receive an image of a finger or other input object captured at the first computing device prior to recordation of the touch input onto the surface of the first computing device.

Block S120 can also implement machine vision techniques to identify a portion of the image corresponding to the input object and crop the image accordingly. Block S120 can also apply similar methods or techniques to identify multiple regions of the image that each correspond to an input object (e.g., a finger), and Block S120 can then cooperate to pair each of the regions with a particular input point or contact area specified in the touch-related data collected in Block S110. Block S120 can also adjust lighting, color, contrast, brightness, focus, and/or other parameters of the image (or cropped regions of the image) before passing the image to Block S130 for rendering on the display.

Alternatively, Block S120 can receive or retrieve a stock image of the input object. For example, Block S120 can access a graphical image representative of the object based on an object type manually selected (i.e., by a user) or automatically detected at the first mobile computing device. In this example, the graphical image can be a cartoon of a corresponding object type. Similarly, Block S120 can select or receive digital photographic image of a similar object type, such as a photographic image of a hand, a finger, lips, etc. of another user, such as of a hand, finger, or lip model. For example, Block S120 can select a photographic image of a modeled forefinger or a photographic image of modeled lips from a database of stock images stored on a remote server or locally on the second computing device. Yet alternatively, Block S120 can select or retrieve a previous (i.e., stored) image of the actual input object, such as a digital photographic image of an actual hand, finger, or lips of a user entering the input into the first computing device, though the photographic image was captured at an earlier time and/or on an earlier date than entry of the input onto the first computing device. In this implementation, Block S120 can similarly crop and/or adjust the image to match or correct the image to the second computing device.

Block S120 can receive a single image of the input object one “touch event” over which the input object contacts the surface of the first computing device and moves across the surface of the computing device (e.g., in a gesture), and Block S130 can manipulate the image (e.g., according to the input-related data collected in Block S110) rendered on the display during the touch event. For example, the first computing device can prompt a first user to capture an image of his right index finger before entering shared inputs onto the first computing device with his right index finger. In this example, Block S120 can receive this image of the right index finger, and Block S130 can render the image at different locations on the display in the second computing device as the first user moves his right index finger around the surface of the first computing device (i.e., based on input-related data collected in Block S110). Thus, Block S120 can collect a single image for each touch event initiating when the first user touches the surface of the first computing device and terminating when the first user removes the touch (i.e., the touch object) from the surface of the computing device. Block S120 can also collect and store the single image for a series of touch events. For example, the first computing device can capture the image of the input object when a touch sharing application executing on the first computing device is opened, and Block S120 can receive and apply this image to all subsequent touch events captured on the first computing device while the touch sharing application is open and the recorded touch events are mimicked at the second computing device. Alternatively, Block S120 can repeatedly receive images captured by the first computing device during a touch event, such as images captured at a constant rate (e.g., 1 Hz) or when an input on the surface of the first computing device moves beyond a threshold distance (e.g., 0.25″) from a location of a previous image capture. However, Block S120 can function in any other way to capture, receive, and/or collect any other suitable type of image visually representative of the input object in contact with the first computing device or in any other way in response to any other event and at any other rate.

Block S110 and Block S120 can receive image- and touch-related data from the first computing device via a cellular, Wi-Fi, or Bluetooth connection. However, Block S110 and Block S120 can receive the foregoing data through any other wired or wireless communication channel, such as directly from the first computing device or over a computer network (e.g., the Internet via a remote server). However, Block S110 can function in any other way to receive a position of a touch input on a touchscreen of a first computing device, and Block S120 can function in any other way to receive an image related to the input on the first computing device.

### 5. Visual Representation of Touch

Block S130 of the method recites displaying the image on a display of a second computing device, the second computing device including a dynamic tactile layer arranged over the display and defining a set of deformable regions, each deformable region in the set of deformable region configured to expand from a retracted setting into an expanded setting. (Block S130 of the method can similarly recite displaying the image on a display of the second mobile computing device, the second mobile computing device including a dynamic tactile layer arranged over the display and defining a set of deformable regions, each deformable region in the set of deformable region configured to expand from a retracted setting into an expanded setting.) Generally, Block S130 functions to manipulate the image and to control the display of the second computing device to visually render the image on the second computing device, thereby providing visual feedback through the display in conjunction with tactile (or haptic) feedback provided through the dynamic tactile interface on the second computing device.

In one implementation, Block S130 fuses input data collected in Block S110 with the image collected in Block S120 to transform (e.g., scale, rotate, translate) the image onto the display. For example, Block S130 can estimate a contact area of an object on the first computing device based on the input data, match the sensed contact area with a region of the image associated with an input object (e.g., a finger, a stylus, a cheek), and then scale, rotate, and/or translate the image to align the region of the image with the sensed contact area. In a similarly example, for an input area received in Block S110, Block S130 can scale and rotate a region of the image corresponding to the input object to match a size and orientation of the input area. Block S130 can further transform the image and the input data to align the region of the image (and therefore the contact area) with one or more deformable regions of the image and/or based on a layout (e.g., length and width) of the display. For example, Block S130 can display a region of the image on the display under a particular deformable region, the region of the image scaled for the size (i.e., perimeter) of the particular deformable region. In a similar example, Block S130 can project a region of an image of a finger from the display through one or more deformable regions defining a footprint approximating the contact area of the finger.

In another example of the foregoing implementation, Block S120 receives a static image of a hand of the first user—with fingers spread wide—and Block S110 receives touch data specifying five initial touch points recorded at approximately the same time as the image was captured (e.g., within 500 milliseconds), wherein each touch point corresponds to a fingertip. Block S130 then implements machine vision techniques to identify five fingers in the image and pairs each of the five initial touch point positions with one of the fingers identified in the image. In particular, in this example, Block S130 can implement edge detection, block discovery, or an other machine vision technique to identify areas of the image corresponding to fingertips, calculate an area center (or centroid) of each identified fingertip area, and pair area centers of regions of the image with touch points received in Block S110. Alternatively, Block S130 can match areas of fingertip regions in the image with touch areas received in Block S110, such as based on size, shape, and/or relative position from other fingertip regions and touch areas. Block S130 can thus transform all or portions of the image to match the positions and orientation of select regions of the image with the touch input locations received in Block S110 and then render this transformed image on the display of the second computing device.

Furthermore, in the foregoing example, Block S110 can receive additionally touch-related data as a first user moves one or more fingers over the surface of the first computing device, and Block S130 can transform (e.g., translate, rotate, scale) select regions of the rendered image to follow new touch areas or touch points received from the first computing device. Alternatively, Block S130 can update the display on the second computing device with new images received in Block S120 and corresponding to changes in the touch input location on the first computing device.

Thus, Block S130 can fuse touch input data collected in Block S110 with one or more images collected in Block S120 to assign quantitative geometric data (e.g., shape, size, relative position, special properties, etc.) to all or portions of each image. For example, Block S130 can ‘vectorize’ portions of the image based on geometric (e.g., distance, angle, position) data extracted from the touch-related data collected in Block S110, and Block S130 can manipulate (i.e., transform) portions of the image by adjusting distances and/or angles between vectors in the vectorized image. For example, Block S130 can scale the image to fit on or fill the display of the second computing device and/or rotate the image based on an orientation of the second computing device (e.g., relative to gravity). Block S130 can also transform the image and adjust touch input locations based on known locations of the deformable regions in the dynamic tactile interface of the second computing device such that visual representations of the touch object (e.g., the first user's fingers) rendered on the display align with paired tactile representations of the touch object formed on the dynamic tactile layer.

In one example implementation, Block S130 extracts relative dimensions of the input object from the image, correlates two or more points of contact on the first computing device—received in Block S110—with respective points of the image corresponding to the input object, determines the actual size of the input object in contact with the first computing device based on a measurable distance between points of contact in the input data and the correlated points in the image, and predicts a size and geometry of the contact area of the input object on first computing device accordingly. Block S130 can further cooperate with Blocks S110 and S140 to pair regions of the image rendered on the display with one or more deformable regions of the dynamic tactile interface on the second computing device to mimic both haptic and visual components of touch. For example, Block S130 can manipulate the image, such as with a keystone, an inverse-fisheye effect, or a filter to display a substantially accurate (e.g., “convincing”) two-dimensional representation of the input object in alignment with a corresponding deformable region above, the position of which is set in Block S140.

Block S130 can thus implement image processing techniques to manipulate the image based on points or areas in the image correlated with contact points or contact areas received in Block S110. Block S130 can also implement human motion models to transform one or more contact points or contact areas into a moving visual representation of the input object corresponding to movement of the input object over the surface of the first computing device, such as substantially in real-time or asynchronously. However, Block S130 can function in any other way to manipulate and/or render the image on the display of the second computing device.

### 6. Tactile Representation of Touch

Block S140 of the method recites, in response to receiving the location of the touch input, transitioning a particular deformable region in the set of deformable regions from the retracted setting into the expanded setting, the particular deformable region defined within the dynamic tactile layer at a position corresponding to the location of the touch input. (Block S140 of the method can similarly recite transitioning a particular deformable region in the set of deformable regions from the retracted setting into the expanded setting, the particular deformable region defined within the dynamic tactile layer at a position corresponding to the location of the touch input and elevated above the dynamic tactile layer in the expanded setting.) Generally, Block S140 functions—at the second mobile computing device—to tactilely imitate a touch input entered into the first computing device (e.g., by a first user) to remotely share the touch with a second user. In particular, Block S140 manipulates deformable regions defined within a dynamic tactile interface integrated into or incorporated onto the second computing device, as described above and in U.S. patent application Ser. No. 13/414,589.

As described above, the dynamic tactile interface includes: a substrate defining an attachment surface, a fluid channel, and discrete fluid conduits passing through the attachment surface; a tactile layer defining a peripheral region bonded across the attachment surface and a set of discrete deformable regions, each deformable region adjacent the peripheral region, arranged over a fluid conduit, and disconnected from the attachment surface; and a displacement device configured to selectively expanded deformable regions in the set of deformable regions from a retracted setting to an expanded setting, wherein deformable regions in the expanded setting are tactilely distinguishable from the peripheral region. For example, the dynamic tactile layer can include one or more displacement devices configured to pump volumes of fluid through the fluid channel and one or more particular fluid conduits to selectively expand corresponding deformable regions. Block S140 can thus selectively actuate the displacement device(s) to displace fluid toward one or more select deformable regions, thereby transitioning the one or more select deformable regions into the expanded setting. The dynamic tactile layer can also include one or more valves arranged between the displacement device(s) and the deformable region(s). Block S140 can therefore also include setting a position of one or more valves to selectively direct fluid through the substrate toward one or more select deformable regions. The dynamic tactile layer can thus define multiple discrete deformable regions, and Block S140 can control one or more actuators within the dynamic tactile layer (e.g., a displacement device, a valve) to displace controlled volumes of fluid toward select deformable regions to imitate a touch tactilely as shown in FIG. 5. However, the dynamic tactile layer can include any other suitable system, components, actuators, etc. enabling a reconfigurable surface profile controllable in Block S140 to mimic—on a second computing device—a touch input onto a first computing device.

In one implementation, Block S140 receives a touch input data—including a location (e.g., point or area) of a touch input—from Block S110 and implements these data by selectively transitioning one or a subset of deformable regions—corresponding to the location of the touch input—in the dynamic tactile layer on the second computing device into the expanded setting. For example, when a first user touches a particular location on the first computing device with his right index finger and this touch is captured by a touch sensor within the first computing device, Block S110 can transmit data specific to this touch event to the second computing device. In this example, Block S140 can thus raise a particular deformable region at a position on the second computing device corresponding to the particular location on the first computing device. As described above, Block S130 further renders the image of the input object (i.e., the first user's right index finger) on a region of the display of the second computing device below and substantially aligned with the particular deformable region. Blocks S130 and S140 can thus cooperate to visually and tactilely represent—on the second computing device—an input on the first computing device.

In one implementation, Blocks S110 and S140 receive the location of the touch input and transition the particular deformable region into the expanded setting, respectively, substantially in real-time with application of the touch input onto the surface of the first computing device. Alternatively, Block S140 can implement touch input data collected in Block S110 asynchronously, such as by replaying a touch input previously entered into the first computing device and stored in memory as touch data on the second computing device. For example, Block S110 can store the location of the touch input in memory on the second computing device, and Block S140 can asynchronously retrieve the location of the touch input from memory in the second computing device, transform the location into a corresponding coordinate position on the dynamic tactile layer, and then transition a particular deformable region—defined in the dynamic tactile layer proximal the corresponding coordinate position—into the expanded setting.

Block S140 can further receive a touch input size and geometry from Block S110 and implement these data by raising a subset of deformable regions on the second computing device to imitate the size and geometry of the touch input. In this implementation, the dynamic tactile interface of the second computing device can define a tixel display including an array of substantially small (e.g., two millimeter-square) and independently actuated deformable regions, and Block S110 can receive a map (e.g., Cartesian coordinates of centers of discrete areas) of a contact patch of a first user's hand in contact with a touch sensor in the first computing device. Block S140 can implement touch data collected in Block S110 by selectively transitioning a subset of deformable regions in the tixel display to physically approximate—on the second computing device—the shape of the first user's hand in contact with the first computing device. For example, Block S110 can receive a contact area of the touch input onto the surface of the first computing device, and Block S140 can transition a subset of deformable regions (i.e., “tixels” in the tixel array) from the retracted setting into the expanded setting, wherein the subset of deformable regions are arranged across a region of the second computing device corresponding to the location of the touch input on the first computing device, and wherein the subset of deformable regions define a footprint on the second computing device approximating the contact area of the touch input on the first computing device. Furthermore, in this example and as described above, Block S120 can receive an image of an input object (e.g., a finger) captured at the first computing device prior to recording the touch input onto the surface of the first computing device, and Block S130 can project the image of the input object from the display through the subset of deformable regions, the image of the input object thus aligned with and scaled to the footprint of the subset of deformable regions.

In the foregoing implementation, Block S140 can thus physically render the contact patches of five fingers, the base of the thumb, and the base of the hand, etc. of the first user on the second computing device by selectively expanding deformable regions (i.e., tixels) aligned with an image of the first user's hand rendered on the display of the second computing device below.

As described above, Block S110 can also receive pressure data related to the touch input on the first computing device, and Block S140 can transition one or more select deformable regions of the dynamic tactile interface of the second computing device according to the pressure data received in Block S110. In one example, Block S140 controls an internal fluid pressure behind each deformable region of the dynamic tactile interface according to recorded pressures applied to corresponding regions of the surface of the first computing device. In particular, in this example, Block S140 can set the firmness and/or height of select deformable regions on the second computing device by controlling fluid pressures behind the deformable regions, thereby remotely imitating the vertical form, stiffness, force, and/or pressure of touches applied over the surface of the first computing device. Therefore, as in this example, Block S140 can implement pressure data related to the touch input collect in Block S110 to recreate—on the dynamic tactile interface of the second computing device—the curvature of a hand, a finger, lips, or an other input object incident on the first computing device. However, Block S140 can implement pressure data collected in Block S110 in any other suitable way.

In a similar implementation, Block S140 analyzes the touch input data collected in Block S110 to predict a three-dimensional form of the input object incident on the surface of the first computing device. In this implementation, Block S140 subsequently expands a subset of deformable regions on the second computing device to particular heights above the dynamic tactile layer to approximate the predicted three-dimensional form of the input object. For example, Block S140 can extrapolate a three-dimensional form of the input object from a force distribution of the touch input onto the surface of the first computing device, as collected in Block S110, and then transition a subset of (i.e., one or more) deformable regions into the expanded setting by pumping a volume of fluid into corresponding cavities behind the subset of deformable regions based on the recorded force distribution of the touch input. Block S140 can thus remotely reproduce a shape or form of the input object—incident on the first computing device—at the second computing device.

In the foregoing implementation, Block S140 can additionally or alternatively execute machine vision techniques to calculate or extrapolate a three-dimensional form of the input object from the image received in Block 120 to estimate a three-dimensional form of the input object and adjust a vertical position of a particular deformable region on the second computing device accordingly. Block S140 can thus also remotely reproduce a shape or form of the input object—near but not into contact with the first computing device—at the second computing device. Block S140 can similarly fuse touch input data collected in Block S110 with digital photographic data of the input object collected in Block S120 to estimate a three-dimensional form of the input object and adjust a vertical position of a particular deformable region on the second computing device accordingly.

Furthermore, as the first user moves his hand and/or a finger (or other input object) across the surface of the first computing device, Block S110 can receive updated maps of the contact patch of the first user's hand, such as at a refresh rate of 2 Hz, and Block S140 can update deformable regions in the dynamic tactile layer of the second computing device according to the updated contact patch map. In particular, Block S140 can update the dynamic tactile layer to physically (i.e., tactilely) render—on the second computing device—movement of the touch across the first computing device, such as substantially in real-time, such as shown in FIG. 4. For example, Block S110 can receive current touch data of the first computing device at a refresh rate of 2 Hz (i.e., twice per second), and Block S140 can implement these touch data by actively pumping fluid into and out of select deformable regions according to current touch input data, such as also at a refresh rate of ˜2 Hz.

Block S110 can similarly collect time-based input data, such as a change in size of a contact patch, a change in position of the contact patch, or a change in applied force or pressure on the surface of the first computing device over time. In this implementation, Block S140 can implement these time-based data by changing vertical positions of select deformable regions at rates corresponding to changes in the size, position, and/or applied force or pressure of the touch input. For example, Block S110 can receive input-related data specifying an increase in applied pressure on a surface of the first computing device over time, and Block S140 can pump fluid toward and away from a corresponding deformable region on the second computing device at commensurate rates of change.

As described above, Block S110 can also receive temperature data of the touch input on the first computing device. In this implementation, Block S140 can control one or more heating and/or cooling elements arranged in the second computing device to imitate a temperature of the touch on the first computing device. In one example, the second computing device includes a heating element in-line with a fluid channel between a deformable region and the displacement device, and Block S140 controls power to the heating element to heat fluid pumped into the deformable region. In this example, Block S140 can control the heating element to heat a volume of fluid before or while the fluid is pumped toward the deformable region. Thus, Block S110 can receive a temperature of the touch input onto the surface of the first computing device, and Block S140 can displace heated fluid toward a particular deformable region (e.g., into a corresponding cavity in the dynamic tactile layer) based on the received temperature of the touch input. In another example, the second computing device includes one or more heating elements arranged across one or more regions of the display, and Block S140 controls power (i.e., heat) output from the heating element(s), which conduct heat through the display, the substrate, and/or the tactile layer, etc. of the dynamic tactile interface to yield a sense of temperature change on an adjacent surface of the second computing device. In yet another example, the second computing device includes one heating element arranged adjacent each deformable region (or subset of deformable regions), and Block S140 selectively controls power output from each heating element according to a temperature data (e.g., a temperature map) collected in Block S110 to replicate—on the second computing device—a temperature gradient measured across a surface of the first computing device. In this example, Block S140 can selectively control heat output into each deformable region (e.g., tixel). However, Block S140 can manipulate a temperature of all or a portion of the dynamic tactile layer of the second computing device in any other way to imitate a recorded temperature of the input on the first computing device.

However, Block S140 can function in any other way to outwardly deform a portion of the dynamic tactile layer in the second computing device to remotely reproduce (i.e., imitate, mimic) a touch input on another device. Block S140 can also implement similar methods or techniques to inwardly deform (e.g., retract below a neutral plane) one or more deformable regions of the dynamic tactile layer or manipulate the dynamic tactile layer in any other suitable way to reproduce—at the second computing device—an input onto the first computing device.

### 7. Input Motion

One variation of the method includes Block S150, which recites transitioning the particular deformable region from the expanded setting into the retracted setting in response to withdrawal of the object from the location on the surface of the first mobile computing device, the particular deformable region substantially with the dynamic tactile layer in the retracted setting. Generally, Block S150 functions to update the dynamic tactile interface according to a change of position of the input on the touch sensor of the first computing device. In particular, Block S150 transitions an expanded deformable region back into the retracted retraction in response to a release of the input object from the corresponding location on the surface of the first computing device. In one example, when a first user withdraws an input object (e.g., a finger, stylus) from the first computing device, Block S110 receives this touch input update from the first computing device, and Block S150 implements this update by retracting deformable regions arranged over corresponding areas of the second computing device from expanded settings to the retracted setting (or to lower elevated positions above the peripheral region). However, Block S150 can function in any other way to retract one or more deformable regions of the dynamic tactile layer on the second computing device in response to withdrawal of the touch input on the touchscreen of the first computing device.

In one implementation, Block S150 furthers receives a motion of the touch input from the location to a second location on the surface of the first computing device, transitions the particular deformable region into the retracted setting, and transitions a second deformable region in the set of deformable regions from the retracted setting into the expanded setting, the second deformable region defined within the dynamic tactile layer at a second position corresponding to the second location of the touch input, such as shown in FIG. 4. In particular, in this implementation, Block S150 can dynamically change the vertical heights (e.g., positions between the retracted and expanded settings inclusive) of various deformable regions on the dynamic tactile layer of the second computing device based a change in a position and/or orientation of one or more touch locations on the first computing device, as described above. In this implementation, as Block S140 transitions select deformable regions responsive to a change in the current input location on the first computing device (or to a change in the input location specified in a current “frame” of a recording), Block 130 can similar transform (e.g., rotate, translate, scale) the same image rendered on the display to accommodate the changing position of a tactile formation rendered on the dynamic tactile layer. For example, Block 130 can render the image on the display at an initial position proximal a particular deformable region in response to receiving a first location and then transforming the image to a subsequent position proximal a second deformable region in response to identifying motion of the touch input to a second corresponding location. Alternatively, Block S120 can receive a second image related to the second location (i.e., an image of the input object captured when the input object was substantially proximal the second location), and then Block S130 can display the second image on the display. Block S150 can thus update a tactile formation rendered on the dynamic tactile layer of the second computing device and Block S130 can update a visual image rendered on the display of the second computing device—in real-time or asynchronously—as the input on the first computing device change. Furthermore, Blocks S110, S120, S130, S140, and S150 can thus cooperate to visually and tactilely represent—on the second computing device—a gesture or other motion across the first computing device in a complementary fashion.

### 8. Two-Way Sharing

As shown in FIG. 6, one variation of the method further includes Block S160, which recites detecting a second location of a second touch input on a surface of the second computing device, selecting a second image related to the second touch input, and transmitting the second location and the second image to the first computing device. Generally, Block S160 functions to implement methods or techniques described above to collect touch-related data and corresponding images for inputs on the second computing device and to transmit these data (directly or indirectly) to the first computing device such that the first computing device—which can incorporate a similar dynamic tactile interface—can execute methods or techniques similar to those of Blocks S110, S120, S130, S140, and/or S150 described above to reproduce on the first computing device a touch entered onto the second computing device. Thus, Block S160 can cooperate with Blocks S110, S120, S130, S140, and/or S150 on the second computing device to both send and receive touches for remote reproduction on an external device and locally on the second computing device, respectively.

In one example, Block S160 can interface with a capacitive touch sensor within the second computing device to detect a location of one or more inputs on a surface of the second computing device. Block S160 can also recalibrate the capacitive (or other) touch sensor based on a topography of the second computing device—that is, positions of deformable regions on the second computing device—to enable substantially accurate identification of touch inputs on one or more surfaces of the second computing device. In this example, Block S160 can also interface with a camera or in-pixel optical sensor(s) (within the display) within the second computing device to capture a series of images of an input object before contact with the second computing device, select a particular image from a set of images captured with the camera, and then crop the selected image around a portion of the second image corresponding to the input object. Furthermore, in this example, Block S160 can retrieve temperature data from a temperature sensor in the second computing device and/or pressure or force data from a strain or pressure gauge within the second computing device, etc. Block S160 can subsequently assembly these location, image, temperature, and/or pressure or force data, etc. into a data packet and upload this packet to a server (e.g., a computer network) for subsequent distribution to the first (or other) computing device or transmit the data packet directly to the first (or other) computing device. However, Block S160 can function in any other way to collect and transmit touch-related data recorded at the second computing device to an external device for substantially real-time or asynchronous remote reproduction.

Block S160 can thus cooperate with other Blocks of the method to support remote touch interaction between two or more users through two or more corresponding computing devices. For example, a first user's touch can be captured by the first computing device and transmitted to the second computing device in Blocks S110 and S120, and a second user's touch can be captured by the second computing device and transmitted to the first computing device in Block S160 simultaneously with or in response to the first user's touch. For example, the first and second users can touch corresponding areas on the touchscreens of their respective computing devices, and the method can execute on each of the computing devices to set the size, geometry, pressure, and/or height of corresponding deformable regions on each computing device according to differences in touch geometry and pressure applied by the first and second users onto their respective computing devices.

### 8. Asynchronous Touch Replication

Though described above as applicable to sharing a touch input between two or more computing devices, methods and techniques described above can be similarly implemented on a single computing device to record and store a touch input and then to playback the touch input recording simultaneously in both visual and tactile formats. Similarly, methods and techniques described above can be implemented on a computing device to play synthetic tactile and/or visual inputs, such as tactile and visual programs not recorded from real (i.e., live) touch events on the same or other computing device. However, Blocks of the method can function in any other way to live or recorded visual and tactile content for human consumption through respective visual and tactile displays.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or computing device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention as defined in the following claims.

I claim:

1. A method for remotely sharing touch, comprising:
receiving a location of a touch input on a surface of a first computing device;
receiving an image related to the touch input;
displaying the image on a display of a second computing device, the second computing device comprising a dynamic tactile layer arranged over the display and defining a set of deformable regions, each deformable region in the set of deformable region configured to expand from a retracted setting into an expanded setting; and
in response to receiving the location of the touch input, transitioning a particular deformable region in the set of deformable regions from the retracted setting into the expanded setting, the particular deformable region defined within the dynamic tactile layer at a position corresponding to the location of the touch input.

2. The method of claim 1, further comprising receiving a motion of the touch input from the location to a second location on the surface of the first computing device, transitioning the particular deformable region into the retracted setting, and transitioning a second deformable region in the set of deformable regions from the retracted setting into the expanded setting, the second deformable region defined within the dynamic tactile layer at a second position corresponding to the second location of the touch input.

3. The method of claim 2, further comprising receiving a second image related to the second location and displaying the second image on the display.

4. The method of claim 2, wherein displaying the image comprises rendering the image on the display at an initial position proximal the particular deformable region in response to receiving the location and transforming the image to a subsequent position proximal the second deformable region in response to receiving the motion of the touch input to the second location.

5. The method of claim 1, wherein receiving the location of the touch input and transitioning the particular deformable region into the expanded setting comprise receiving the location of the touch input and transitioning the particular deformable region into the expanded setting substantially in real-time with application of the touch input onto the surface of the first computing device.

6. The method of claim 5, further comprising transitioning the particular deformable region into the retracted setting in response to withdrawal of the touch input onto the surface of the first computing device.

7. The method of claim 1, wherein receiving the location of the touch input comprises storing the location in memory in the second computing device, and wherein transitioning the particular deformable region into the expanded setting comprises retrieving the location of the touch input from memory in the second computing device, transforming the location into a corresponding coordinate position on the dynamic tactile layer, and transitioning the particular deformable region defined at the corresponding coordinate position into the expanded setting.

8. The method of claim 1, wherein receiving the location of the touch input comprises receiving a contact area of the touch input onto the surface of the first computing device, and wherein transitioning the particular deformable region into the expanded setting comprises transitioning a subset of deformable regions in the set of deformable regions from the retracted setting into the expanded setting, the subset of deformable regions proximal the position corresponding to the location and defining a footprint approximating the contact area of the touch input.

9. The method of claim 8, wherein receiving the image comprises receiving an image of a finger captured at the first computing device prior to recording the touch input onto the surface of the first computing device, wherein receiving the contact area of the touch input onto the surface of the first computing device comprises receiving the contact area of the finger on the surface of the first computing device, and wherein displaying the image comprises projecting the image of the finger from the display through the subset of deformable regions defining a footprint approximating the contact area of the finger.

10. The method of claim 8, wherein receiving the location of the touch input comprises predicting a three-dimensional form of an object applying the touch input onto the surface of the first computing device, and wherein transitioning the subset of deformable regions into the expanded setting comprises expanding deformable regions in the subset of deformable regions to particular heights above the dynamic tactile layer to approximate the three-dimensional form of the object.

11. The method of claim 1, wherein receiving the image comprises retrieving a stock image for an input implement selected at the first computing device and scaling a size of the stock image for the display of the second computing device.

12. The method of claim 1, wherein transitioning the particular deformable region into the expanded setting comprises actuating a pump within the second computing device to displace fluid into a cavity defined by the particular deformable region.

13. The method of claim 12, wherein receiving the location of the touch input comprises receiving a force of the touch input onto the surface of the first computing device, and wherein transitioning the particular deformable region into the expanded setting comprises pumping a volume of fluid into the cavity based on the force of the touch input.

14. The method of claim 12, wherein transitioning the particular deformable region into the expanded setting comprises setting a position of a valve to selectively direct fluid toward the cavity.

15. The method of claim 12, further comprising receiving a temperature of the touch input onto the surface of the first computing device, wherein actuating the pump comprises displacing heated fluid into the cavity based on the temperature of the touch input.

16. The method of claim 1, further comprising
detecting a second location of a second touch input on a surface of the second computing device,
selecting a second image related to the second touch input, and
transmitting the second location and the second image to the first computing device.

17. The method of claim 16, wherein selecting the second image comprises selecting the second image from a set of images captured through a camera integrated into the second computing device prior to the second touch input and cropping the second image around a portion of the second image corresponding to an input object.

18. A method for remotely sharing touch, comprising:
at a second mobile computing device, receiving a location of a touch input on a surface of a first mobile computing device;
receiving an image of an object applying the touch input onto the surface of the first mobile computing device;
displaying the image on a display of the second mobile computing device, the second mobile computing device comprising a dynamic tactile layer arranged over the display and defining a set of deformable regions, each deformable region in the set of deformable region configured to expand from a retracted setting into an expanded setting;
transitioning a particular deformable region in the set of deformable regions from the retracted setting into the expanded setting, the particular deformable region defined within the dynamic tactile layer at a position corresponding to the location of the touch input and elevated above the dynamic tactile layer in the expanded setting; and
transitioning the particular deformable region from the expanded setting into the retracted setting in response to withdrawal of the object from the location on the surface of the first mobile computing device, the particular deformable region substantially with the dynamic tactile layer in the retracted setting.

19. The method of claim 18, wherein receiving the image comprises selecting a graphical image representative of the object based on an object type selected at the first mobile computing device.

20. The method of claim 18, wherein transitioning the particular deformable region into the expanded setting comprises pumping a volume of fluid through a fluid channel toward a cavity corresponding to the particular deformable region within the dynamic tactile layer.
